(19) United States
(12) Patent Application Publication
(10) Pub. No.: US 2014/0303332 A1
(43) Pub. Date: Oct. 9, 2014

(54) CATALYST FOR OLEFIN POLYMERIZATION AND COPOLYMERIZATION, AND OLEFIN POLYMERIZATION OR COPOLYMERIZATION METHOD USING SAME

(71) Applicants: Chun Byung Yang, Seoul (KR); Joon Ryeo Park, Seoul (KR)

(72) Inventors: Chun Byung Yang, Seoul (KR); Joon Ryeo Park, Seoul (KR)

(21) Appl. No.: 14/360,544

(22) PCT Filed: Jun. 21, 2012
(86) PCT No.: PCT/KR2012/004904

§ 371 Date: May 23, 2014

(30) Foreign Application Priority Data
Nov. 24, 2011 (KR) 10-2011-0123751

(51) Int. Cl. C08F 210/16

(52) U.S. Cl. CPC C08F 210/16
USPC 526/113; 502/129; 502/120

(57) ABSTRACT

The provided is an olefin (co)polymerization catalyst with an excellent catalyst activity, wherein the catalyst component is prepared by using a metallocene compound and titanocene compound or a half-titanocene compound so as to provide polyolefins having a high molecular weight and a low melt index, and also a method for olefin (co)polymerization using said catalyst.

### TECHNICAL FIELD

The present invention relates to a catalyst for olefin (co)polymerization and a method for olefin (co)polymerization using the same. Specifically, the present invention relates to an olefin (co)polymerization catalyst with an excellent catalyst activity, wherein the catalyst component is prepared by using a metallocene compound and titanocene compound or a half-titanocene compound so as to provide a polyolefin having a high molecular weight and a low melt index, and to a method for olefin (co)polymerization using thus obtained catalyst.

### BACKGROUND OF THE INVENTION

A metallocene is represented as a general formula of LₙMQₚ, wherein M is a metal of Group IIIB, IVB, VB or VIB; Q is a C1-C20 hydrocarbyl group or halogen; p is a value of an atomic valance of the metal M-2; and L is a ligand bonded to the metal M. An olefin (co)polymer may be prepared by using such metallocene compound together with a cocatalyst, methyl aluminoxane (MAO). Methyl aluminoxane (hereinafter, interchangeably referred as “MAO”) includes a linear and/or cyclic methyl aluminoxane oligomer, in which when it is a linear methyl aluminoxane oligomer, it is represented as a chemical formula R—(Al(R)—O)ₙ—AlR₂, and when it is a cyclic methyl aluminoxane oligomer, it is represented as a chemical formula (—Al(R)—O—)ₘ, wherein R is a C1-C8 alkyl, preferably methyl; n is an integer of 1-40, preferably 10-20; m is an integer of 3-40, preferably 3-20. Methyl aluminoxane is typically prepared by reacting trimethyl aluminum with water or hydrated inorganic salts such as CuSO₄.H₂O or Al₂(SO₄)₃.H₂O. Alternatively, methyl aluminoxane may be produced on the same phase in a polymerization reactor by adding trimethyl aluminum and water or hydrous inorganic salts to the reactor. Methyl aluminoxane is a mixture of oligomers having a very broad molecular weight distribution and has a typical weight average molecular weight of about 900-1200. Methyl aluminoxane is generally remained in the form of a solution in toluene.

Such metallocene catalyst should be supported on a proper support so as to be used in a fluidized bed reactor or a slurry reactor, and each catalyst particle comprises metallocene which is supported on a support should have a sufficient activity so as not to make a problem related to catalyst support residues. One of the representative methods for preparing a supported metallocene catalyst currently developed and used is to react a metallocene catalyst component together methyl aluminoxane with a silica support (refer to U.S. Pat. Nos. 4,808,561, 4,897,455, 5,240,894). In this method, the hydroxyl groups of silica and methyl aluminoxane react together so that methyl aluminoxane can be supported on the surface of silica, and then a metallocene catalyst is supported on the methyl aluminoxane. The metallocene catalyst component may be supported on silica, simultaneously with methyl aluminoxane or after supporting methyl aluminoxane, through a separate supporting reaction. The activity of the supported catalyst is in proportion to the amount of the supported metallocene component as well as the amount of the supported methyl aluminoxane which aids supporting of a metallocene catalyst component. Methyl aluminoxane not only help supporting of a metallocene catalyst but also protecting the metallocene catalyst component from a catalyst poison. Therefore, the amount of the supported methyl aluminoxane directly affects to the catalyst activity.

An activity of the supported metallocene catalyst is a major factor which directly affects to catalyst economy. However, in most cases of said supporting methods, the resulted metallocene catalyst has much lowered catalyst activity compared to the non-supported catalyst. In this regard, many of the supported metallocene catalysts do not satisfy catalyst economy, depending on the catalyst types. Further, another important factor regarding availability of the supported metallocene catalyst is the capability of producing polyolefins having sufficiently high molecular weight as required, in a polymerization reaction under commercial operation conditions, by using the supported catalyst. There are many metallocene catalysts which cannot produce polyolefins having sufficiently high molecular weight, under commercial operation conditions, especially in the presence of hydrogen for adjusting the molecular weight. In such cases, the value of such catalyst is considered low, no matter how the economics for preparing a catalyst is good.

In order to improve the catalyst activity of the supported metallocene catalyst, many researches have been made. For example, a method for preparing a catalyst by reacting MAO and a metallocene compound with a functional silica support which has been prepared by reacting organic silicon compound with silica (see, U.S. Pat. Nos. 4,874,734 and 5,206,199; Makromol. Chem., 1993, 194, 3499; J. Mol. Cat. A:Chem., 2000, 154, 103; and J. Mol. Cat. A:Chem., 2003, 197, 233); a method for preparing a catalyst by reacting MAO and a metallocene compound with a functional silica support which has been prepared by reacting organic tin compound with silica (see, U.S. Pat. No. 6,908,876; EP 1613667 A2; WO 2004094480 A2; Makromol. Reaction Eng., 2008, 2, 339; J. Appl. Polym. Sci. 2007, 106, 3149); a method for preparing a catalyst by reacting MAO and a metallocene compound with a functional silica support which has been prepared by reacting silicon tetrachloride (SiCl₄) with silica (Makromol. Rapid Commun., 2002, 23, 672); and a method which uses a product obtained from supporting a reaction mixture of MAO and diol (Bisphenol A) on silica as a support (EP 0685494) have been reported. Although the metallocene supported catalyst prepared according to the above methods of prior arts, in many cases, can improve the catalystic activity depending on the Lewis acid level of the organic silicon compound or organic tin compound used, there is a tendency for the molecular weight of the produced polymer to be reduced as the reaction rate of the chain termination is faster than that of the chain growth depending on such acid level. In this regard, it is difficult to produce a polyolefin having a sufficiently high molecular weight as required, under commercial operation conditions, in the present of hydrogen for molecular weight adjustment, disadvantageously.

In the meantime, studies for improving properties of a catalyst have been made by adding a metallocene catalyst with MAO to the polymerization reaction of an organic compound which is a Lewis base. For example, a method which introduces a metallocene catalyst together with MAO to the polymerization reaction of tetrahydrofuran, ethyl benzoate and acetonitrile (J. Polym. Sci., Part A: Polym. Chem. 1991, 29, 1595) and a method which introduces a metallocene catalyst together with MAO to the polymerization reaction of hydrosilanes such as tBuMe₂SiH, Et₃SiH, poly(hydromethylsiloxane) (U.S. Pat. Nos. 6,939,930 and 6,642,326) have been reported. Although these methods are effective in increasing the molecular weight of a polymer, they deteriorate an activity of the catalyst, thereby reducing an economics of the catalyst preparation.

The issue of making improvements in an activity of such supported metallocene catalyst and a molecular weight of a finally obtained polymer is based on the metallocene catalyst itself, therefore it may be achieved by designing and synthesizing a novel metallocene catalyst which has an excellent activity and provides a polymer having a high molecular weight. However, it requires a lot of efforts and time to design and synthesize such novel metallocene catalyst, with a very thin possibility of successes. Therefore, there has been needs for an improved catalyst having an increased activity and providing a polymer having a high molecular weight, and a method for preparing the same by making an appropriate development in a supported metallocene catalyst.

### SUMMARY OF THE INVENTION

The present invention is to solve the forgoing problems of prior arts, with the purpose of providing an olefin (co)polymerization catalyst having an excellent catalystic activity by using a supported metallocene catalyst component and a titanocene compound or half-titanocene compound.

Another purpose of the present invention is to provide an olefin (co)polymerization method which can produce an olefin (co)polymer having a high molecular weight and a low melt index by using the catalyst of the present invention.

### DETAILED DESCRIPTION OF THE INVENTION

The olefin (co)polymerization catalyst with an excellent catalyst activity, which provides an olefin (co)polymer having a high molecular weight, is characteristically prepared by the method comprising:

(1) supporting aluminoxane, a metallocene compound and a titanocene compound or half-titanocene compound onto a support;

(2) washing the supported catalyst obtained from the above step (1) with an organic solvent; and

(3) drying the catalyst washed from the above step (2) and thus collecting the catalyst in the form of powder.

In the preparation method for a polyolefin catalyst according to the present invention, the supporting step of the above step (1) may be conducted by adding a solution obtained by dissolving a metallocene compound together with a titanocene compound or half-titanocene compound into an aluminoxane solution to a support slurry, and stirring the mixture (supporting process (a)). Alternatively, the supporting reaction of the step (1) may be conducted by adding aluminoxane to a support slurry, stirring the mixture for supporting the aluminoxane to the support, thereby obtaining an aluminoxane supported support slurry, and adding thereto a metallocene compound and a titanocene compound or half-titanocene compound and stirring the mixture (supporting process (b)).

The kind of a metallocene compound used in the above step (1), which is not specifically limited, is preferably, for example, dicyclopentadienyl metallocene or cross-linked metallocene or monocyclopentadienyl metallocene.

Firstly, the dicyclopentadienyl metallocene may be represented as the following chemical formula (1):

(CpRₙ)(CpR′ₘ)ML_{q} (1)

wherein, Cp is cyclopentadienyl, indenyl, or fluorenyl; each R and R′ independently is hydrogen, alkyl, alkylether, allylether, phosphine or amine;
L is alkyl, allyl, arylalkyl, amide, alkoxy or halogen;
M is a transition metal of Group 4 or 5 in the periodic table; and
each of n, m and q is an integer within the following range: 0≦n<5, 0≦m<5, and 1≦q≦4.

The cross-linked metallocene may be represented as the following chemical formula (2):

Q(CpRₙ)(CpR′ₘ)ML_{q} (2)

wherein, each of Cp, R, R′, M and L has the same meaning as defined in the chemical formula (1); Q is a crosslinkage between the C cycles, such as dialkyl, alkylaryl, diaryl silicon, or C1-C20 hydrocarbon group; each of n, m and q is an integer within the following range: 0≦n<4, 0≦m<4, and 1≦q≦4.

The monocyclopentadienyl metallocene may be represented as the following chemical formula (3):

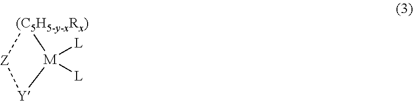

wherein, x is 0, 1, 2, 3 or 4; y is 0 or 1; R is hydrogen, or a substituent having 1-20 non-hydrogen atoms selected from the group consisting of C1-C20 hydrocarbon group, silyl, germyl, cyano, halogen and a combination thereof; Y′ is —O—, —S—, —NR*—, or —PR*— (wherein R* is hydrogen, C1-C12 hydrocarbon group, C1-C8 hydrocarbyloxy, silyl, C1-C8 halogenated alkyl, C6-C20 halogenated aryl or a combination thereof); Z is SiR*₂, CR*₂, SiR*₂SiR*₂, CR*₂CR*₂, CR*═CR*, CR*₂SiR*₂ or GeR*₂, wherein R* has the same meaning as defined above; each L independently is a substituent having 1-20 non-hydrogen substituent selected from the group consisting of halide, C1-C20 hydrocarbon group, C1-C18 hydrocarbyloxy, C1-C19 hydrocarbylamino, C1-C18 hydrocarbylamide, C1-C18 hydrocarbylphosphide, C1-C18 hydrocarbylsulfide and combinations thereof, or two Ls together represent C1-C30 neutral conjugated dien or divalent group; and M is a transition metal of Group 4 or 5 of the periodic table.

The dicyclopentadienyl metallocene represented as the chemical formula (1), may include bis(cyclopentadienyl) metallocenes, such as bis(cyclopentadienyl)zirconium dimethyl, bis(methylcyclopentadienyl)zirconium dimethyl, bis(n-butylcyclopentadienyl)zirconium dimethyl, bis(indenyl)zirconium dimethyl, bis(1,3-dimethylcyclopentadienyl)zirconium dimethyl, (pentamethylcyclopentadienyl)(cyclopentadienyl)zirconium dimethyl, bis(pentamethylcyclopentadienyl)zirconium dimethyl, bis(fluorenyl)zirconium dimethyl, bis(2-methylindenyl)zirconium dimethyl, bis(2-phenylindenyl)zirconium dimethyl, cyclopentadienyl(2-phenylindenyl)zirconium dimethyl and the like. The cross-linked metallocenes represented as the above chemical formula (2), may include dimethylsilylbis(1-indenyl)zirconium dimethyl, dimethylsilyl(9-fluorenyl)(1-cyclopentadienyl)zirconium dimethyl, dimethylsilylbis(1-cyclopentadienyl)zirconium dimethyl, dimethylsilyl(9-fluorenyl)(1-indenyl)zirconium dimethyl, dimethylsilylbis(1-indenyl)hafnium dimethyl, dimethylsilyl(9-fluorenyl)(1-cyclopentadienyl)hafnium dimethyl, dimethylsilylbis(1-cyclopentadienyl)hafnium dimethyl, dimethylsilyl(9-fluorenyl)(1-indenyl)hafnium dimethyl, ethylene bis(1-cyclopentadienyl)zirconium dimethyl, ethylene bis(1-indenyl)zirconium dimethyl, ethylene bis(4,5,6,7-tetrahydro-1-indenyl)zirconium dimethyl, ethylene bis(4-methyl-1-indenyl)zirconium dimethyl, ethylene bis(5-methyl-1-indenyl)zirconium dimethyl, ethylene bis(6-methyl-1-indenyl)zirconium dimethyl, ethylene bis(7-methyl-1-indenyl)zirconium dimethyl, ethylene bis(4-phenyl-1-indenyl)zirconium dimethyl, ethylene bis(5-methoxy-1-indenyl)zirconium dimethyl, ethylene bis(2,3-dimethyl-1-indenyl)zirconium dimethyl, ethylene bis(4,7-dimethyl-1-indenyl)zirconium dimethyl, ethylene bis(4,7-dimethoxy-1-indenyl)zirconium dimethyl, ethylene bis(trimethylcyclopentadienyl)zirconium dimethyl, ethylene bis(5-dimethylamino-1-indenyl)zirconium dimethyl, ethylene bis(6-dipropylamino-1-indenyl)zirconium dimethyl, ethylene bis(4,7-bis(dimethylamino)-1-indenyl)zirconium dimethyl, ethylene bis(5-diphenylphosphino-1-indenyl)zirconium dimethyl, ethylene(1-dimethylamino-9-fluorenyl)(1-cyclopentadienyl)zirconium dimethyl, ethylene(4-butylthio-9-fluorenyl)(1-cyclopentadienyl)zirconium dimethyl, ethylene(9-fluorenyl)(1-cyclopentadienyl)zirconium dimethyl, ethylene bis(9-fluorenyl)zirconium dimethyl, ethylene bis(1-cyclopentadienyl)hafnium dimethyl, ethylene bis(1-indenyl)hafnium dimethyl, ethylene bis(4,5,6,7-tetrahydro-1-indenyl)hafnium dimethyl, ethylene bis(4-methyl-1-indenyl)hafnium dimethyl, ethylene bis(5-methyl-1-indenyl)hafnium dimethyl, ethylene bis(6-methyl-1-indenyl)hafnium dimethyl, ethylene bis(7-methyl-1-indenyl)hafnium dimethyl, ethylene bis(4-phenyl-1-indenyl)hafnium dimethyl, ethylene bis(5-methoxy-1-indenyl)hafnium dimethyl, ethylene bis(2,3-dimethyl-1-indenyl)hafnium dimethyl, ethylene bis(4,7-dimethyl-1-indenyl)hafnium dimethyl, ethylene bis(4,7-dimethoxy-1-indenyl)hafnium dimethyl, ethylene bis(trimethylcyclopentadienyl)hafnium dimethyl, ethylene bis(5-dimethylamino-1-indenyl)hafnium dimethyl, ethylene bis(6-dipropylamino-1-indenyl)hafnium dimethyl, ethylene bis(4,7-bis(dimethylamino)-1-indenyl)hafnium dimethyl, ethylene bis(5-diphenylphosphino-1-indenyl)hafnium dimethyl, ethylene(1-dimethylamino-9-fluorenyl)(1-cyclopentadienyl)hafnium dimethyl, ethylene(4-butylthio-9-fluorenyl)(1-cyclopentadienyl)hafnium dimethyl, ethylene(9-fluorenyl)(1-cyclopentadienyl)hafnium dimethyl, ethylene bis(9-fluorenyl)hafnium dimethyl, 2,2-propyl bis(1-cyclopentadienyl)zirconium dimethyl, 2,2-propyl bis(1-indenyl)zirconium dimethyl, 2,2-propyl bis(4,5,6,7-tetrahydro-1-indenyl)zirconium dimethyl, 2,2-propyl bis(4-methyl-1-indenyl)zirconium dimethyl, 2,2-propyl bis(5-methyl-1-indenyl)zirconium dimethyl, 2,2-propyl bis(6-methyl-1-indenyl)zirconium dimethyl, 2,2-propyl bis(7-methyl-1-indenyl)zirconium dimethyl, 2,2-propyl bis(4-phenyl-1-indenyl)zirconium dimethyl, 2,2-propyl bis(5-methoxy-1-indenyl)zirconium dimethyl, 2,2-propyl bis(2,3-dimethyl-1-indenyl)zirconium dimethyl, 2,2-propyl bis(4,7-dimethyl-1-indenyl)zirconium dimethyl, 2,2-propyl bis(4,7-dimethoxy-1-indenyl)zirconium dimethyl, 2,2-propyl bis(trimethylcyclopentadienyl)zirconium dimethyl, 2,2-propyl bis(5-dimethylamino-1-indenyl)zirconium dimethyl, 2,2-propyl bis(6-dipropylamino-1-indenyl)zirconium dimethyl, 2,2-propyl bis(4,7-bis(dimethylamino)-1-indenyl)zirconium dimethyl, 2,2-propyl bis(5-diphenylphosphino-1-indenyl)zirconium dimethyl, 2,2-propyl(1-dimethylamino-9-fluorenyl) (1-cyclopentadienyl) zirconium dimethyl, 2,2-propyl(4-butylthio-9-fluorenyl)(1-cyclopentadienyl)zirconium dimethyl, 2,2-propyl(9-fluorenyl)(1-cyclopentadienyl)zirconium dimethyl, 2,2-propyl bis(9-fluorenyl)zirconium dimethyl, 2,2-propyl bis(1-cyclopentadienyl)hafnium dimethyl, 2,2-propyl bis(1-indenyl)hafnium dimethyl, 2,2-propyl bis(4,5,6,7-tetrahydro-1-indenyl)hafnium dimethyl, 2,2-propyl bis(4-methyl-1-indenyl)hafnium dimethyl, 2,2-propyl bis(5-methyl-1-indenyl)hafnium dimethyl, 2,2-propyl bis(6-methyl-1-indenyl)hafnium dimethyl, 2,2-propyl bis(7-methyl-1-indenyl)hafnium dimethyl, 2,2-propyl bis(4-phenyl-1-indenyl)hafnium dimethyl, 2,2-propyl bis(5-methoxy-1-indenyl)hafnium dimethyl, 2,2-propyl bis(2,3-dimethyl-1-indenyl)hafnium dimethyl, 2,2-propyl bis(4,7-dimethyl-1-indenyl)hafnium dimethyl, 2,2-propyl bis(4,7-dimethoxy-1-indenyl)hafnium dimethyl, 2,2-propyl bis(trimethylcyclopentadienyl)hafnium dimethyl, 2,2-propyl bis(5-dimethylamino-1-indenyl)hafnium dimethyl, 2,2-propyl bis(6-dipropylamino-1-indenyl)hafnium dimethyl, 2,2-propyl bis(4,7-bis(dimethylamino)-1-indenyl)hafnium dimethyl, 2,2-propyl bis(5-diphenylphosphino-1-indenyl)hafnium dimethyl, 2,2-propyl(1-dimethylamino-9-fluorenyl)(1-cyclopentadienyl)hafnium dimethyl, 2,2-propyl(4-butylthio-9-fluorenyl)(1-cyclopentadienyl) hafnium dimethyl, 2,2-propyl(9-fluorenyl)(1-cyclopentadienyl)hafnium dimethyl, 2,2-propyl bis(9-fluorenyl)hafnium dimethyl, diphenylmethyl bis(1-cyclopentadienyl)zirconium dimethyl, diphenylmethyl bis(1-indenyl)zirconium dimethyl, diphenylmethyl bis(4,5,6,7-tetrahydro-1-indenyl)zirconium dimethyl, diphenylmethyl bis(4-methyl-1-indenyl)zirconium dimethyl, diphenylmethyl bis(5-methyl-1-indenyl)zirconium dimethyl, diphenylmethyl bis(6-methyl-1-indenyl)zirconium dimethyl, diphenylmethyl bis(7-methyl-1-indenyl)zirconium dimethyl, diphenylmethyl bis(4-phenyl-1-indenyl)zirconium dimethyl, diphenylmethyl bis(5-methoxy-1-indenyl)zirconium dimethyl, diphenylmethyl bis(2,3-dimethyl-1-indenyl)zirconium dimethyl, diphenylmethyl bis(4,7-dimethyl-1-indenyl)zirconium dimethyl, diphenylmethyl bis(4,7-dimethoxy-1-indenyl)zirconium dimethyl, diphenylmethyl bis(trimethylcyclopentadienyl)zirconium dimethyl, diphenylmethyl bis(5-dimethylamino-1-indenyl)zirconium dimethyl, diphenylmethyl bis(6-dipropylamino-1-indenyl)zirconium dimethyl, diphenylmethyl bis(4,7-bis(dimethylamino)-1-indenyl)zirconium dimethyl, diphenylmethyl bis(5-diphenylphosphino-1-indenyl)zirconium dimethyl, diphenylmethyl(1-dimethylamino-9-fluorenyl)(1-cyclopentadienyl)zirconium dimethyl, diphenylmethyl(4-butylthio-9-fluorenyl)(1-cyclopentadienyl)zirconium dimethyl, diphenylmethyl(9-fluorenyl)(1-cyclopentadienyl)zirconium dimethyl, diphenylmethyl bis(9-fluorenyl)zirconium dimethyl, diphenylmethyl bis(1-cyclopentadienyl)hafnium dimethyl, diphenylmethyl bis(1-indenyl)hafnium dimethyl, diphenylmethyl bis(4,5,6,7-tetrahydro-1-indenyl)hafnium dimethyl, diphenylmethyl bis(4-methyl-1-indenyl)hafnium dimethyl, diphenylmethyl bis(5-methyl-1-indenyl)hafnium dimethyl, diphenylmethyl bis(6-methyl-1-indenyl)hafnium dimethyl, diphenylmethyl bis(7-methyl-1-indenyl)hafnium dimethyl, diphenylmethyl bis(4-phenyl-1-indenyl)hafnium dimethyl, diphenylmethyl bis(5-methoxy-1-indenyl)hafnium dimethyl, diphenylmethyl bis(2,3-dimethyl-1-indenyl)hafnium dimethyl, diphenylmethyl bis(4,7-dimethyl-1-indenyl)hafnium dimethyl, diphenylmethyl bis(4,7-dimethoxy-1-indenyl)hafnium dimethyl, diphenylmethyl bis(trimethylcyclopentadienyl)hafnium dimethyl, diphenylmethyl bis(5-dimethylamino-1-indenyl)hafnium dimethyl, diphenylmethyl bis(6-dipropylamino-1-indenyl)hafnium dimethyl, diphenylmethyl bis(4,7-bis(dimethylamino)-1-indenyl)hafnium dimethyl, diphenylmethyl bis(5-diphenylphosphino-1-indenyl)hafnium dimethyl, diphenylmethyl(1-dimethylamino-9-fluorenyl)(1-cyclopentadienyl)hafnium dimethyl, diphenylmethyl(4-butylthio-9-fluorenyl)(1-cyclopentadienyl)hafnium dimethyl, diphenylmethyl(9-fluorenyl)(1-cyclopentadienyl)hafnium dimethyl, diphenylmethyl bis(9-fluorenyl)hafnium dimethyl, diphenylsilyl bis(1-cyclopentadienyl)zirconium dimethyl, diphenylsilyl bis(1-indenyl)zirconium dimethyl, diphenylsilyl bis(4,5,6,7-tetrahydro-1-indenyl)zirconium dimethyl, diphenylsilyl bis(4-methyl-1-indenyl)zirconium dimethyl, diphenylsilyl bis(5-methyl-1-indenyl)zirconium dimethyl, diphenylsilyl bis(6-methyl-1-indenyl)zirconium dimethyl, diphenylsilyl bis(7-methyl-1-indenyl)zirconium dimethyl, diphenylsilyl bis(4-phenyl-1-indenyl)zirconium dimethyl, diphenylsilyl bis(5-methoxy-1-indenyl)zirconium dimethyl, diphenylsilyl bis(2,3-dimethyl-1-indenyl)zirconium dimethyl, diphenylsilyl bis(4,7-dimethyl-1-indenyl)zirconium dimethyl, diphenylsilyl bis(4,7-dimethoxy-1-indenyl)zirconium dimethyl, diphenylsilyl bis(trimethylcyclopentadienyl)zirconium dimethyl, diphenylsilyl bis(5-dimethylamino-1-indenyl)zirconium dimethyl, diphenylsilyl bis(6-dipropylamino-1-indenyl)zirconium dimethyl, diphenylsilyl bis(4,7-bis(dimethylamino)-1-indenyl)zirconium dimethyl, diphenylsilyl bis(5-diphenylphosphino-1-indenyl)zirconium dimethyl, diphenylsilyl(1-dimethylamino-9-fluorenyl)(1-cyclopentadienyl)zirconium dimethyl, diphenylsilyl(4-butylthio-9-fluorenyl)(1-cyclopentadienyl)zirconium dimethyl, diphenylsilyl(9-fluorenyl)(1-cyclopentadienyl)zirconium dimethyl, diphenylsilyl bis(9-fluorenyl)zirconium dimethyl, diphenylsilyl bis(1-cyclopentadienyl)hafnium dimethyl, diphenylsilyl bis(1-indenyl)hafnium dimethyl, diphenylsilyl bis(4,5,6,7-tetrahydro-1-indenyl)hafnium dimethyl, diphenylsilyl bis(4-methyl-1-indenyl)hafnium dimethyl, diphenylsilyl bis(5-methyl-1-indenyl)hafnium dimethyl, diphenylsilyl bis(6-methyl-1-indenyl)hafnium dimethyl, diphenylsilyl bis(7-methyl-1-indenyl)hafnium dimethyl, diphenylsilyl bis(4-phenyl-1-indenyl)hafnium dimethyl, diphenylsilyl bis(5-methoxy-1-indenyl)hafnium dimethyl, diphenylsilyl bis(2,3-dimethyl-1-indenyl)hafnium dimethyl, diphenylsilyl bis(4,7-dimethyl-1-indenyl)hafnium dimethyl, diphenylsilyl bis(4,7-dimethoxy-1-indenyl)hafnium dimethyl, diphenylsilyl bis(trimethylcyclopentadienyl)hafnium dimethyl, diphenylsilyl bis(5-dimethylamino-1-indenyl)hafnium dimethyl, diphenylsilyl bis(6-dipropylamino-1-indenyl)hafnium dimethyl, diphenylsilyl bis(4,7-bis(dimethylamino)-1-indenyl)hafnium dimethyl, diphenylsilyl bis(5-diphenylphosphino-1-indenyl)hafnium dimethyl, diphenylsilyl(1-dimethylamino-9-fluorenyl)(1-cyclopentadienyl) hafnium dimethyl, diphenylsilyl(4-butylthio-9-fluorenyl)(1-cyclopentadienyl)hafnium dimethyl, diphenylsilyl(9-fluorenyl)(1-cyclopentadienyl)hafnium dimethyl and diphenylsilyl bis(9-fluorenyl)hafnium dimethyl.

The monocyclopentadienyl metallocene represented by the above chemical formula (3), may include [(N-t-butylamide)(tetramethyl-η5-cyclopentadienyl)-1,2-ethandiyl]titanium dimethyl, [(N-t-butylamide)(tetramethyl-η5-cyclopentadienyl)-dimethylsilanee]titanium dimethyl, [(N-methylamide)(tetramethyl-η5-cyclopentadienyl)-1,2-ethandiyl]titanium dimethyl, [(N-methylamide)(tetramethyl-η5-cyclopentadienyl)-dimethylsilane]titanium dimethyl, [(N-phenylamide)(tetramethyl-η5-cyclopentadienyl)-dimethylsilane]titanium dimethyl, [(N-benzylamide)(tetramethyl-η5-cyclopentadienyl)-dimethylsilane]titanium dimethyl, (N-methylamide)(η5-cyclopentadienyl)-1,2-ethandiyl]titanium dimethyl, [(N-methylamide)(η5-cyclopentadienyl)-dimethylsilane]titanium dimethyl, [(N-t-butylamide)(η5-indenyl)-dimethylsilane]titanium dimethyl, [(N-benzylamide)(η5-indenyl)-dimethylsilane]titanium dimethyl, dimethylsilyl tetramethyl cyclopentadienyl-tert-butylamido zirconium dimethyl, dimethylsilyl tetramethyl cyclopentadienyl-tert-butylamido hafnium dimethyl, dimethylsilyl tert-butyl cyclopentadienyl-tert-butylamido zirconium dimethyl, dimethylsilyl tert-butyl cyclopentadienyl-tert-butylamido hafnium dimethyl, dimethylsilyl trimethylsilyl cyclopentadienyl-tert-butylamido zirconium dimethyl, dimethylsilyl tetramethyl cyclopentadienyl-phenylamido zirconium dimethyl, dimethylsilyl tetramethyl cyclopentadienyl-phenylamido hafnium dimethyl, methylphenyl silyl tetramethyl cyclopentadienyl-phenylamido zirconium dimethyl, methyl phenyl silyl tetramethyl cyclopentadienyl-phenylamido hafnium dimethyl, methyl phenyl silyl tert-butyl cyclopentadienyl-tert-butylamido zirconium dimethyl, methyl phenyl silyl tert-butyl cyclopentadienyl-tert-butylamido hafnium dimethyl, dimethylsilyl tetramethyl cyclopentadienyl-p-n-phenylamido zirconium dimethyl, dimethylsilyl tetramethyl cyclopentadienyl-p-n-phenylamido hafnium dimethyl, dibromo bis triphenyl phosphine nickel, dichloro bis triphenylphosphinenickel, dibromodiacetonitrile nickel, dibromodibenzonitrile nickel, dibromo(1,2-bis diphenyl phosphinoethane)nickel, dibromo (1,3-bis diphenyl phosphinoethane)nickel, dibromo(1,1′-diphenyl bis phosphinoferrocene) nickel, dimethyl bis diphenyl phosphine nickel, dimethyl(1,2-bis diphenyl phosphinoethane) nickel, methyl(1,2-bis diphenyl phosphinoethane) nickel tetraflouoroborate, (2-diphenylphosphino-1-phenylethylenoxy)phenylpyridine nickel, dichloro bistriphenylphosphine paladium, dichlorodiacetonitrile palladium, dichloro(1,2-bis diphenylphosphinoethane)palladium, bis triphenylphosphine palladium bistetrafluoroborate, bis(2,2′-bipyridine)methyl iron tetrafluoroborate etherate and the like.

Further, those compounds in which the “dimethyl” moiety of each of the above listed titanium, zirconium and hafnium compounds is substituted with compounds such as -dichloro, -dibromo, -diiode, -diethyl, -dibutyl, -dibenzyl, -diphenyl, -bis-2-(N,N-dimethylamino)benzyl, -2-butene-1,4-diyl, -s-trans-η4-1,4-diphenyl-1,3-butadiene, -s-trans-η4-3-methyl-1,3-pentadiene, -s-trans-η4-1,4-dibenzyl-1,3-butadiene, -s-trans-η4-2,4-hexadiene, -s-trans-η4-1,3-pentadiene, -s-trans-η4-1,4-ditolyl-1,3-butadiene, -s-trans-η4-1,4-bis(trimethylsilyl)-1,3-butadiene, -s-cis-η4-1,4-diphenyl-1,3-butadiene, -s-cis-η4-3-methyl-1,3-pentadiene, -s-cis-η4-1,4-dibenzyl-1,3-butadiene, -s-cis-η4-2,4-hexadiene, -s-cis-η4-1,3-pentadiene, -s-cis-η4-1,4-ditolyl-1,3-butadiene, -s-cis-η4-1,4-bis(trimethylsilyl)-1,3-butadiene and the like.

The catalyst system of the present invention may comprise one or more metallocene catalyst components as above. Moreover, further catalyst components, if necessary, such as other well-known catalyst components other than the metallocene catalyst components of the present invention.

As for the metallocene compounds used in the present invention, those prepared by the already well-known methods of published literatures, or those commercially available from mCAT GmBH (see, www.mcat.de) or Strem (see, www.strem.com) or Boulder Scientific (see, www.bouldersci.com) may be used.

The titanocene compounds or half-titanocene compounds used in the step (1) of the present invention are those having a hydrogenation activity. Compounds having a hydrogenation activity reduce the hydrogen concentration in a polymerization reactor by hydrogenating ethylene or α-olefins used therein. It is advantageous that these compounds are prevented from interrupting the polymerization reaction so as not to lower the catalyst performance. As for such compounds having hydrogenation reaction activity, the compounds containing nickel, palladium, ruthenium and platinum, etc. and metallocene compounds having a simple structure have been well-known. In the present invention, a titanocene compound or half-titanocene compound which has a sufficient hydrogenation reaction activity at a polymerization temperature is advantageous. The titanocene compound or half-titanocene compound may be used alone, or after reacting with organic metals such as organic aluminum, organic lithium, organic magnesium.

The titanocene compound or half-titanocene compound having a sufficient hydrogenation reaction activity used in the present invention may be represented as the following formula (4):

(CpRₙ)(CpR′ₘ)TiL_{q} (4)

wherein, Cp is a cyclopentadienyl, indenyl, tetrahydroindenyl or fluorenyl;

each of R and R′ independently is a hydrogen, C1-C20 hydrocarbon group, alkylether, alkylsilyl, allylether, alkoxyalkyl, phosphine or amine;

L is an alkyl, allyl, arylalkyl, amide, alkoxy or halogen; and

each of n, m and q is an integer within the following range: 0≦n<5, 0≦m<5 and 1≦q≦4.

As for the titanocene or half-titanocene compound satisfying the above general formula (4), mentioned may be bis(cyclopentadienyl)titanium dichloride, bis(methylcyclopentadienyl)titanium dichloride, bis(n-butylcyclopentadienyl)titanium dichloride, bis(1,3-dimethylcyclopentadienyl)titanium dichloride, bis(pentamethylcyclopentadienyl)titanium dichloride, bis(tetramethylcyclopentadienyl)titanium dichloride, bis(trimethylsilylcyclopentadienyl)titanium dichloride, bis(1,3-bistrimethylcyclopentadienyl)titanium dichloride, bis(indenyl)titanium dichloride, bis(4,5,6,7-tetrahydro-1-indenyl)titanium dichloride, bis(5-methyl-1-indenyl)titanium dichloride, bis(6-methyl-1-indenyl)titanium dichloride, bis(7-methyl-1-indenyl)titanium dichloride, bis(5-methoxy-1-indenyl)titanium dichloride, bis(2,3-dimethyl-1-indenyl) titanium dichloride, bis(4,7-dimethyl-1-indenyl)titanium dichloride, bis(2,3-dimethoxy-1-indenyl)titanium dichloride, bis(fluorenyl)titanium dichloride, etc. as well as (pentamethylcyclopentadienyl)(cyclopentadienyl)titanium dichloride, (fluorenyl)(cyclopentadienyl)titanium dichloride, (fluorenyl)(pentamethylcyclopentadienyl)titanium dichloride, (indenyl)(pentamethylcyclopentadienyl)titanium dichloride, (indenyl)(fluorenyl)titanium dichloride, (tetrahydroindenyl)(cyclopentadienyl)titanium dichloride, (tetrahydroindenyl)(pentamethylcyclopentadienyl)titanium dichloride, (tetrahydroindenyl)(fluorenyl)titanium dichloride, (cyclopentadienyl)(1,3-bistrimethylsilylcyclopentadienyl)titanium dichloride, (pentamethylcyclopentadienyl)(1,3-bistrimethylsilyl cyclopentadienyl)titanium dichloride, (indenyl)(1,3-bistrimethylsilylcyclopentadienyl)titanium dichloride, (fluorenyl)(1,3-bistrimethylsilylcyclopentadienyl)titanium dichloride, and the like.

Further, mentioned may be those compounds in which the “dichloride” moiety of each of the above listed titanium compounds is substituted with -dibromo, -diiode, -dimethyl, diethyl, -dibutyl, -dibenzyl, -diphenyl, -dimethoxy, methoxychloride, -bis-2-(N,N-dimethylamino)benzyl, -2-butene-1,4-diyl, -s-trans-η4-1,4-diphenyl-1,3-butadiene, -s-trans-η4-3-methyl-1,3-pentadiene, -s-trans-η4-1,4-dibenzyl-1,3-butadiene, s-trans-η4-2,4-hexadiene, -s-trans-η4-1,3-pentadiene, -s-trans-η4-1,4-ditolyl-1,3-butadiene, -s-trans-η4-1,4-bis(trimethylsilyl)-1,3-butadiene, -s-cis-η4-1,4-diphenyl-1,3-butadiene, -s-cis-η4-3-methyl-1,3-pentadiene, -s-cis-η4-1,4-dibenzyl-1,3-butadiene, -s-cis-η4-2,4-hexadiene, -s-cis-η4-1,3-pentadiene, -s-cis-η4-1,4-ditolyl-1,3-butadiene, -s-cis-η4-1,4-bis(trimethylsilyl)-1,3-butadiene and the like.

As for the half-titanocene compound which may be used in the present invention, mentioned may be cyclopentadienyl titanium trichloride, cyclopentadienyl titanium trifluoride, cyclopentadienyl titanium tribromide, cyclopentadienyl titanium triiodide, cyclopentadienyl titanium methyldichloride, cyclopentadienyl titanium dimethylchloride, cyclopentadienyl titanium ethoxydichloride, cyclopentadienyl titanium diethyoxychloride, cyclopentadienyl titanium phenoxidedichloirde, cyclopentadienyl titanium diphenoxidechloride, cyclopentadienyl titanium trimethyl, cyclopentadienyl titanium triethyl, cyclopentadienyl titanium triisopropyl, cyclopentadienyl titanium tri-n-butyl, cyclopentadienyl titanium tri-sec-butyl, cyclopentadienyl titanium trimethoxide, cyclopentadienyl titanium triethoxide, cyclopentadienyl titanium triisopropoxide, cyclopentadienyl titanium tributoxide, cyclopentadienyl titanium triphenyl, cyclopentadienyl titanium tribenzyl, cyclopentadienyl titanium tri-m-tolyl, cyclopentadienyl titanium tri-p-tolyl, cyclopentadienyl titanium tri-m,p-xylyl, cyclopentadienyl titanium tri-4-ethylphenyl, cyclopentadienyl titanium tri-4-hexylphenyl, cyclopentadienyl titanium tri-4-methoxyphenyl, cyclopentadienyl titanium tri-4-ethoxyphenyl, cyclopentadienyl titanium triphenoxide, cyclopentadienyl titanium tri-dimethylamide, cyclopentadienyl titanium tri-diethylamide, cyclopentadienyl titanium tri-diisopropylamide, cyclopentadienyl titanium tri-di-sec-butylamide, cyclopentadienyl titanium tri-di-tert-butylamide, cyclopentadienyl titanium tri-ditriethylsilylamide and the like.

Further, mentioned may be those compounds in which the “cyclopentadienyl” moiety of each of the above listed titanium compounds is substituted with methylcyclopentadienyl, n-butylcyclopentadienyl, 1,3-dimethylcyclopentadienyl, pentamethylcyclopentadienyl, tetramethylpentadienyl, trimethylsilylcyclopentadienyl, 1,3-bistrimethylsilyl cyclopentadienyl, indenyl, 4,5,6,7-tetrahydro-1-indenyl, 5-methyl-1-indenyl, 6-methyl-1-indenyl, 7-methyl-1-indenyl, 5-methoxy-1-indenyl, 2,3-dimethyl-1-indenyl, 4,7-dimethyl-1-indenyl, 4,7-dimethoxy-1-indenyl, fluorenyl and the like.

Examples of half-titanocene compounds are listed as follows.

[(N-t-butylamide)(tetramethyl-η5-cyclopentadienyl)-1,2-ethandiyl]titanium dichloride, [(N-t-butylamide)(tetramethyl-η5-cyclopentadienyl)-dimethylsilane]titanium dichloride, [(N-methylamide)(tetramethyl-η5-cyclopentadienyl)-1,2-ethandiyl]titanium dichloride, [(N-methylamide)(tetramethyl-η5-cyclopentadienyl)-dimethylsilane]titanium dichloride, [(N-phenylamide)(tetramethyl-η5-cyclopentadienyl)-dimethylsilane]titanium dichloride, [(N-benzylamide)(tetramethyl-η5-cyclopentadienyl)-dimethylsilane]titanium dichloride, (N-methylamide)(η5-cyclopentadienyl)-1,2-ethandiyl]titanium dichloride, [(N-methylamide)(η5-cyclopentadienyl)-dimethylsilane]titanium dichloride, [(N-t-butylamide)(η5-indenyl)-dimethylsilane]titanium dichloride, [(N-benzylamide)(η5-indenyl)-dimethylsilane]titanium dichloride and the like.

Further, mentioned may be those compounds in which the “dichloride” moiety of each of the above listed half-titanocene compounds is substituted with -dibromo, -diiodide, -dimethyl, diethyl, -dibutyl, -dibenzyl, -diphenyl, -dimethoxy, methoxychloride, -bis-2-(N,N-dimethylamino)benzyl, -2-butene-1,4-diyl, -s-trans-η4-1,4-diphenyl-1,3-butadiene, -s-trans-η4-3-methyl-1,3-pentadiene, -s-trans-η4-1,4-dibenzyl-1,3-butadiene, s-trans-η4-2,4-hexadiene, -s-trans-η4-1,3-pentadiene, -s-trans-η4-1,4-ditolyl-1,3-butadiene, -s-trans-η4-1,4-bis(trimethylsilyl)-1,3-butadiene, -s-cis-η4-1,4-diphenyl-1,3-butadiene, -s-cis-η4-3-methyl-1,3-pentadiene, -s-cis-η4-1,4-dibenzyl-1,3-butadiene, -s-cis-η4-2,4-hexadiene, -s-cis-η4-1,3-pentadiene, -s-cis-η4-1,4-ditolyl-1,3-butadiene, -s-cis-η4-1,4-bis(trimethylsilyl)-1,3-butadiene and the like.

The titanocene compound and half-titanocene compound may be used alone or in combination. Further, the above described titanocene compounds or half-titanocene compounds may also be used after reacting with organic aluminum, organic lithium or organic magnesium.

As for the organic aluminum which can be reacted and used with the titanocene compound or half-titanocene compound, mentioned may be trialkylaluminum, dialkylaluminum halide, alkylaluminum dihalide, and more specifically trimethylaluminum, triethylaluminum, tributylaluminum, triisobutylaluminum, trihexyl aluminum, trioctylaluminum, tridecylaluminum, dimethylaluminum chloride, diethylaluminum chloride, ethylaluminum dichloride, diethylethoxyaluminum and the like.

As for the organic lithium which can be reacted and used with the titanocene compound or half-titanocene compound, lithium compound of the following formula: RLi(wherein R is a hydrocarbon group comprising an C1-C10 alkyl, alkoxy, alkylamide, C6-C12 allyl, allyloxy, arylamide, C7-C20 alkylallyl, alkylallyloxy, alkylallylamide, arylalkoxy, aryalkylamide, and C2-C20 alkenyl) may be mentioned, and specifically includes methyllithium, ethyllithium, isopropyllithium, n-butyllithium, sec-butyllithium, tert-butyllithium, methoxylithium, isopropoxylithium, butoxylithium, dimethylamidelithium, diethylamidelithium, diisopropylamidelithium, dibutylamidelithium, diphenylamidelithium, phenyllithium, m-tolyllithium, p-tolyllithium, xylyllithium, methoxyphenyllithium, phenoxylithium, benzyllithium and the like.

As for the organic magnesium which can be reacted and used with the titanocene compound or half-titanocene compound, mentioned may be dialkylmagnesium, alkylmagnesium halide, etc., and specifically includes dimethyl magnesium, diethyl magnesium, dibutyl magnesium, diisobutyl magnesium, dihexyl magnesium, dioctyl magnesium, methylmagnesium bromide, methylmagnesium chloride, ethylmagnesium bromide, ethylmagnesium chloride, butylmagnesium bromide, butylmagnesium chloride, hexylmagnesium bromide, hexylmagnesium chloride, phenylmagnesium bromide, phenylmagnesium chloride, allylmagnesium bromide, allylmagnesium chloride and the like.

The molar ratio of a titanocene compound or half-titanocene compound: a metallocene catalyst, which are used in the step (1) of the present invention, is preferably 0.03:1-10:1. When the ratio is less than 0.03:1, the effect increasing a molecular weight of a polymer becomes too small undesirably, in the meanwhile, when it is more than 10:1, the polymerization activity is largely deteriorated disadvantageously.

The aluminoxane used in the step (1) is at least one selected from linear and cyclic aluminoxane oligomers: when it is a linear aluminoxane oligomer, it is represented as a chemical formula of R—(Al(R)—O)ₙ—AlR₂; and when it is a cyclic aluminoxane oligomer, it is represented as a chemical formula of (—Al(R)—O—)ₘ, wherein R is a C1-C8 alkyl group, preferably methyl; n is an integer of 1-40, preferably 10-20; m is 3-40, preferably 3-20. The aluminoxane is a mixture of oligomers with a very wide molecular weight distribution and an average molecular weight of about 800-1200, usually remained as a solution in toluene, and includes, for example 10% or 30% methyl aluminoxane, etc. manufactured by Albemarle Corporation.

When the step (1) is carried out by using the supporting process (a), the aluminoxane concentration in a solution obtained by dissolving a metallocene compound and a titanocene compound or half-titanocene compound in an aluminoxane solution is 5-30 wt %, and the concentration of the metallocene catalyst component is preferably 0.001-1.0 wt % calculated on a metal atom basis. When the concentration of each component is out of said range, the catalyst activity will be disadvantageously too low or high.

Said solution may comprise an aromatic or aliphatic hydrocarbon, or aliphatic cyclic hydrocarbon as a solvent.

The support used in the step (1) is a porous, preferably inorganic material, such as silicone and/or aluminum oxide, in the form of a solid particulate, and most preferably silica having OH groups or other functional groups containing active hydrogen atoms, in the form of a spheric particle, for example obtained by a spray drying method.

The support has an average particle size of 10-250 μm, preferably of 10-150 μm, micropores of which average diameter is 50-500 Å and volume is 0.1-10 ml/g and preferably 0.5-5 ml/g, and a surface area of 5-1000 m²/g and preferably 50-600 m²/g.

When silica is used as a support, it should have at least some active hydroxyl groups [OH], of which concentration is preferably 0.5-2.5 mmole per silica (g), more preferably 0.7-1.6 mmole/g. When the concentration of the hydroxyl group is less than 0.5 mmole/g, the amount of the supported aluminoxane is reduced, it undesirably leads a decrease in catalyst activity, and when it is more than 2.5 mmol/g, the catalyst component is deactivated by the hydroxyl groups, disadvantageously.

The hydroxyl group of said silica can be detected by IR spectroscopy, and the hydroxyl group concentration can be determined by contacting a silica sample with methyl magnesium bromide so as to measure the amount of foamed methane (by measuring pressure).

The silica having the [OH] concentration and physical properties suitable for the present invention is those having a surface area of 300 m²/g and a pore volume of 1.6 ml/g, which are commercially available under the trade name of XPO-2402, XPO-2410, XPO-2411 and XPO-2412 from Davison chemical division of W.R. Grace and company, and further wet silica commercially available under the trade name of Davision 948, 952 and 955 be used herein after adjusting the [OH] concentration to a desired level through a heating process.

The supporting process in the step (1) is preferably carried out by supporting aluminoxane and then metallocene on a support, wherein when silica is used as a support in the step (1), under the anhydrous conditions without oxygen, the hydroxyl groups of the silica provide the sites for supporting the metallocene by reaction with the aluminoxane to be supported and simultaneously, protect a metallocene which is likely to lose its activity by being sensitive to and reacting with external catalytic poisons. Accordingly, the more the amount of aluminoxane being supported, the more the amount of metallocene being supported, and the catalyst activity is increased owing to the increase in probability not to be affected by any external catalytic poison.

The support slurry used in the step (1) is prepared by suspending a support in a hydrocarbon solvent or a hydrocarbon solvent mixture.

The temperature during the supporting process in the step (1) is preferably 40-160° C. and more preferably 80-120° C.: when it is out of said temperature range, the catalyst activity is lowered and the polymers get agglomerated in a reactor, disadvantageously, and time taken for the supporting process is preferably 30 minutes-4 hours, and more preferably 1-2 hours: when the time is out of said range, the economics for preparing a catalyst is lowered or the reaction is not sufficient enough to function as a catalyst, disadvantageously.

In the supported catalyst solution obtained by completing the supporting process of the step (1), a small amount of unreacted aluminoxane and metallocene which are not supported are present, and they need to be removed before being subjected to the drying step. If such unreacted aluminoxane is not removed, those supported catalysts stick together, posing a poor injection problem when injecting the catalyst in a dried form into a polymerization reactor. The injection of such agglomerated catalysts causes problems such as a sheet and agglomerate owing to the localized overreaction in the reactor. Further, unsupported metallocene is easily separated from the supported catalyst in the course of a polymerization reaction so as to form a polymer in the form of very fine particles which may cause a problem of reactor fouling.

For the purpose of removing such unsupported residues, the supported catalyst is washed in the step (2), preferably with organic solvents such as an aromatic and aliphatic hydrocarbon solvent, etc. through two separate times. In the first washing step, the unsupported metallocene and aluminoxane are removed, in the meantime, if the detachment of already supported metallocenes occurs in this step, it would lower the supported catalyst activity. In this regard, in order to prevent such problems, the first washing step is carried out at a lower temperature so that fixing of the supported metallocene and aluminoxane components can be strengthen, thereby preventing the supported metallocene components from being detached during the subsequent secondary washing step. The temperature for the first washing step is preferably in the range of −10-60° C.

The drying process in the step (3) may be carried out by conventional drying processes.

The Al content in the supported metallocene catalyst prepared according to the method of the present invention as above is more than 10 wt %.

The olefin polymerization method using an olefin polymerization catalyst prepared by the method of the present invention comprises reacting a gas phase polymerization composition comprised of hydrogen, olefin, and as necessary, comonomer(s), in the presence of, as a main catalyst, a supported metallocene catalyst prepared as above, thereby preparing olefin polymers or copolymers.

As for the olefin, for example, ethylene may be mentioned, and in this case, alpha-olefins other than ethylene such as propylene, 1-butene, 1-hexene, 4-methyl-1-pentene, etc. are preferred as the comonomer, the molar ratio of the comonomer/ethylene content is preferably 0.005-0.02, and more preferably 0.008-0.015. When the molar ratio of the comonomer/ethylene is less than 0.005 or more than 0.02, copolymer in a desired level cannot be obtained, disadvantageously.

In the method for producing olefin (co)polymers, a metallocene catalyst is blended with at least one activator to form an olefin polymerization catalyst system. As for the preferred activator, there are alkylaluminum compound (for example, diethylaluminum chloride), aluminoxane, modified aluminoxane, neutral or ionic ionization activator, non-coordinated anion, non-coordinated Group 13 metal or metalloid anion, borane, borate and the like.

AS for the alkylaluminum compound, those represented by a chemical formula or AlRₙX₍₃₋ₙ₎ (wherein, R is a C1-C16 alkyl; X is a halogen atom; and 1≦n≦3) may be used. The specific examples of the alkylaluminum compound include preferably, triethylaluminum, trimethylaluminum, trinormalpropylaluminum, trinormalbutylaluminum, triisobutylaluminum, trinormalhexylaluminum, trinormaloctylaluminum, tri-2-methylpentylaluminum and the like, more preferably, triisobutylaluminum, triethylaluminum, trinormalhexylaluminum or trinormaloctylaluminum.

The alkylaluminum compounds are preferably used at the following molar ratio in a gas phase polymerization, depending on the desired polymer properties:

1≦alkylaluminum compound/transition metal in the main catalyst 1000;

more preferably,

10≦alkylaluminum compound/transition metal in the main catalyst≦300.

In the above, when the molar ratio of the alkylaluminum compound/transition metal in the main catalyst is less than 1, sufficient polymerization activity is not obtained, and when it is more than 1000, the polymerization activity is lowered, adversely.

In the method for producing olefin (co)polymers as above, the polymerization reaction is preferably carried out, in the absence of a hydrocarbon solvent, preferably at the temperature of 60-120° C., more preferably 65-100° C., most preferably 70-80° C., preferably under the pressure of 2-40 atm, and more preferably 10˜30 atm.

When the polymerization temperature in the reactor is less than 60° C., the polymerization efficiency is not sufficiently obtained, and when it is more than 120° C., polymers agglomerates are likely to be generated, disadvantageously. Further, when the operation pressure in the reactor is less than 2 atm, the ethylene partial pressure is so low that sufficient polymerization efficiency may not be obtained, and when it is more than 40 atm, it is difficult to control the reaction and burden the reactor, undesirably.

The supported metallocene catalyst prepared as above in the present invention may be used in a prepolymerized form with ethylene or α-olefins before being introduced into the polymerization reaction as a main catalyst. Prepolymerization may be carried out in the presence of said catalyst component and an organometallic compound, and hydrocarbon solvent such as hexane at a sufficiently low temperature and ethylene or α-olefin pressure conditions. Such prepolymerization helps improving the polymer morphology after the polymerization, as the catalyst particles are surrounded by polymers which helps maintaining the catalyst shape. The weight ratio of the polymer/catalyst after prepolymerization is generally 0.1:1 to 200:1. Preferred organometallic compounds include trialkylaluminums which have a C1-C6 alkyl group, such as triethylaluminum, triisobutylaluminum, and mixtures thereof. Sometimes, organic aluminum compounds having at least one halogen or hydride group such as ethylaluminum dichloride, diethylaluminum chloride, ethylaluminum sesquichloride, and diisobutylaluminum hydride may be used.

### INDUSTRIAL AVAILABILITY

By using the catalyst of the present invention for producing polymers, wherein the catalyst has an excellent catalyst activity and is prepared by using a metallocene compound and a titanocene or half-titanocene compound, it is possible to produce polymers having high molecular weight and low melt index.

Further, the resulted product from the polymerization method of the present invention is a homopolymer or copolymer which has high molecular weight in a solid form and excellent bulk density and flowability, and the polymer production yield is high enough to eliminate the need for removing catalyst residues.

### EXAMPLES

Hereinafter, the present invention is further illustrated through the following examples. However, these examples are only provided with an exemplary purposes, without any intention to limit the scope of the present invention.

### Preparation of the Metallocene Supported Catalyst

### Example 1

As shown in Table 1, 5 g of commercially available dehydrated silica under the trade name of XPO-2402 (having average particle size ˜50 microns, surface area 300 m²/g, micropore volume 1.6 ml/g and OH concentration 1 mmol/g) was weighed under the anhydrous condition, and stirred together with 20 ml toluene into the slurry form. The obtained slurry was introduced into a 1 L reactor equipped with a stirrer and a condenser for cooling. After 50 ml of a methyl aluminoxane solution (10 wt %) was measured in a mass cylinder, thereto a metallocene compound, Et(IND)₂ZrCl₂ (metallocene/silica=140 μmol/g silica) and a titanocene compound Cp₂TiCl₂ (Cp₂TiCl₂/silica=140 μmol/g silica) which were measured in a 250 ml Schlenk flask were mixed at a room temperature and stirred for 5 minutes so as to dissolve the solid metallocene compound and Cp₂TiCl₂ and simultaneously react them together. Thus obtained methyl aluminoxane-metallocene solution was added to the reactor while maintaining the reactor temperature to room temperature. Next, the reaction temperature was raised to 110° C. with stirring.

At the temperature, the supporting reaction was carried on for 90 minutes. After completing the reaction, the reaction product was transferred to a Schlenk flask, and supernatant thereof was decanted. The remained reaction product was stirred; when it reached to room temperature, it was allowed to stand for 10 minutes; again the supernatant was decanted; and the remained portion of the reaction product was firstly washed with 100 ml of toluene at −5° C. The first washed reaction product was stirred again; when it reached to room temperature, it was allowed to stand; the supernatant was decanted; and the remained portion was secondly washed with 100 ml toluene at room temperature. Thus obtained catalyst was washed with a purified hexane, and then dried under a moderate vacuum condition. The amount of the supported catalyst as prepared above was 9.4 g.

### Comparative Example 1

A catalyst was prepared as in Example 1, except eliminating the use of Cp₂TiCl₂ from Example 1.

### Example 2

A catalyst was prepared as in Example 1, except replacing Et(IND)₂ZrCl₂ in Example 1 to (IND)₂ZrCl₂ as a metallocene compound.

### Comparative Example 2

A catalyst was prepared as in Example 2, except eliminating the use of Cp₂TiCl₂ from Example 2.

### Example 3

A catalyst was prepared as in Example 1, except replacing Et(IND)₂ZrCl₂ in Example 1 to (nBuCp)₂ZrCl₂ as a metallocene compound.

### Comparative Example 3

A catalyst was prepared as in Example 3, except eliminating the use of Cp₂TiCl₂ from Example 3.

### Example 4

A catalyst was prepared as in Example 1, except replacing Et(IND)₂ZrCl₂ in Example 1 to (1,3-Et,MeCp)₂ZrCl₂ as a metallocene compound.

### Comparative Example 4

A catalyst was prepared as in Example 4, except eliminating the use of Cp₂TiCl₂ from Example 4.

### Comparative Example 5

A catalyst was prepared as in Example 1, except eliminating the use of Et(IND)₂ZrCl₂ from Example 1.

### Comparative Example 6

A catalyst was prepared as in Example 1, except eliminating the use of Et(IND)₂ZrCl₂ from Example 1 and using Cp₂TiCl₂ (Cp₂TiCl₂/silica=200 μmol/g silica).

### Preparation of Polymers

In the following Examples 5-17 and Comparative examples 7-23, polymerization without using hydrogen as a molecular weight modifier is carried out.

### Example 5

Following the conditions shown in Table 1, polymerization was carried out by the following method using the supported metallocene catalyst prepared in Example 1.

To a 2 L stainless steel reactor equipped with a stirrer and heating/cooling device, 1000 ml of purified hexane and 1-hexene of which amount was specified in Table 1 were introduced. The reactor was sufficiently purged with pure nitrogen before use. Next, 1.0 cc of triisobutylaluminum (TiBA) diluted in 1M hexane as a catalytic poison remover was introduced into the reactor, stirred with temperature elevation and stopped stirring when reached to 65° C. As a main catalyst, 15-25 mg of the supported metallocene catalyst prepared in the above step was weighed in a glove box and transferred to 5 ml syringe, and 1.0 cc triisobutylaluminum(TiBA) diluted in 1M hexane was added as an activator. The activated catalyst slurry was transferred and injected into a reactor at 65° C. Next, the reactor temperature was raised to 80° C., with feeding ethylene so that the total pressure in the reactor reached to 200 psig, and the reaction was started by stirring at 1000 rpm. During the reaction, ethylene was fed in a sufficient amount enough to consistently maintain the total pressure of the reactor at 200 psig, and the polymerization reaction was conducted for 20 minutes. After the polymerization reaction for 20 minutes, ethylene feed was stopped to terminate the reaction, thereby obtaining the polymer in result. The resulted polymer was separated through a filter, sufficiently dried to obtain the desired polymer. The polymerization results were shown in Table 1.

Thus obtained polymer was subjected to the following analysis.

1) Density (g/mL): according to the method based on ASTM1505.

2) Melt Index (MI) (2.16 Kg, g/10 min.): according to the method based on ASTM1238.

### Example 6

Polymerization was carried out under the same conditions as in Example 5, except adjusting the amount of 1-hexene from 60 mL to 50 mL. The polymerization conditions and results were shown in Table 1.

### Example 7

Polymerization was carried out under the same conditions as in Example 5, except adjusting the amount of 1-hexene from 60 mL to 40 mL. The polymerization conditions and results were shown in Table 1.

### Example 8

Polymerization was carried out under the same conditions as in Example 5, except adjusting the amount of 1-hexene from 60 mL to 30 mL. The polymerization conditions and results were shown in Table 1.

### Comparative Example 7

Polymerization was carried out under the same conditions as in Example 5, except replacing the catalyst with one from Comparative example 1. The polymerization conditions and results were shown in Table 1.

### Comparative Example 8

Polymerization was carried out under the same conditions as in Comparative Example 7, except adjusting the amount of 1-hexene from 60 mL to 50 mL. The polymerization conditions and results were shown in Table 1.

### Comparative Example 9

Polymerization was carried out under the same conditions as in Comparative example 7, except adjusting the amount of 1-hexene from 60 mL to 40 mL. The polymerization conditions and results were shown in Table 1.

### Comparative Example 10

Polymerization was carried out under the same conditions as in Comparative example 7, except adjusting the amount of 1-hexene from 60 mL to 30 mL. The polymerization conditions and results were shown in Table 1.

### Example 9

Polymerization was carried out under the same conditions as in Example 5, except using a catalyst from Example 2 and adjusting the amount of 1-hexene to 80 mL. The polymerization conditions and results were shown in Table 1.

### Example 10

Polymerization was carried out under the same conditions as in Example 5, except using a catalyst from Example 2. The polymerization conditions and results were shown in Table 1.

### Example 11

Polymerization was carried out under the same conditions as in Example 5, except using a catalyst from Example 2 and adjusting the amount of 1-hexene to 50 mL. The polymerization conditions and results were shown in Table 1.

### Example 12

Polymerization was carried out under the same conditions as in Example 5, except using a catalyst from Example 2 and adjusting the amount of 1-hexene to 40 mL. The polymerization conditions and results were shown in Table 1.

### Comparative Example 11

Polymerization was carried out under the same conditions as in Example 5, except using a catalyst from Comparative example 2 and adjusting the amount of 1-hexene to 80 mL. The polymerization conditions and results were shown in Table 1.

### Comparative Example 12

Polymerization was carried out under the same conditions as in Comparative example 11, except adjusting the amount of 1-hexene from 80 mL to 50 mL. The polymerization conditions and results were shown in Table 1.

### Comparative Example 13

Polymerization was carried out under the same conditions as in Comparative example 11, except adjusting the amount of 1-hexene from 80 mL to 40 mL. The polymerization conditions and results were shown in Table 1.

### Comparative Example 14

Polymerization was carried out under the same conditions as in Comparative example 11, except adjusting the amount of 1-hexene from 80 mL to 30 mL. The polymerization conditions and results were shown in Table 1.

### Example 13

Polymerization was carried out under the same conditions as in Example 5, except using a catalyst from Example 3 and adjusting the amount of 1-hexene to 70 mL. The polymerization conditions and results were shown in Table 1.

### Example 14

Polymerization was carried out under the same conditions as in Example 5, except using a catalyst from Example 3 and adjusting the amount of 1-hexene to 50 mL. The polymerization conditions and results were shown in Table 1.

### Example 15

Polymerization was carried out under the same conditions as in Example 5, except using a catalyst from Example 3 and adjusting the amount of 1-hexene to 40 mL. The polymerization conditions and results were shown in Table 1.

### Comparative Example 15

Polymerization was carried out under the same conditions as in Example 5, except using a catalyst from Comparative example 3 and adjusting the amount of 1-hexene to 70 mL. The polymerization conditions and results were shown in Table 1.

### Comparative Example 16

Polymerization was carried out under the same conditions as in Comparative example 15, except adjusting the amount of 1-hexene from 70 mL to 50 mL. The polymerization conditions and results were shown in Table 1.

### Comparative Example 17

Polymerization was carried out under the same conditions as in Comparative example 15, except adjusting the amount of 1-hexene from 70 mL to 40 mL. The polymerization conditions and results were shown in Table 1.

### Example 16

Polymerization was carried out under the same conditions as in Example 5, except using a catalyst from Example 4 and adjusting the amount of 1-hexene to 70 mL. The polymerization conditions and results were shown in Table 1.

### Example 17

Polymerization was carried out under the same conditions as in Example 5, except using a catalyst from Example 4 and adjusting the amount of 1-hexene to 40 mL. The polymerization conditions and results were shown in Table 1.

### Comparative Example 18

Polymerization was carried out under the same conditions as in Example 5, except using a catalyst from Comparative example 4 and adjusting the amount of 1-hexene to 70 mL. The polymerization conditions and results were shown in Table 1.

### Comparative Example 19

Polymerization was carried out under the same conditions as in Comparative Example 18, except adjusting the amount of 1-hexene from 70 mL to 40 mL. The polymerization conditions and results were shown in Table 1.

### Comparative Example 20

Polymerization was carried out under the same conditions as in Example 5, except using a catalyst from Comparative example 5 and adjusting the amount of 1-hexene to 70 mL. The polymerization conditions and results were shown in Table 1.

### Comparative Example 21

Polymerization was carried out under the same conditions as in Comparative example 20, except adjusting the amount of 1-hexene from 70 mL to 20 mL. The polymerization conditions and results were shown in Table 1.

### Comparative Example 22

Polymerization was carried out under the same conditions as in Example 5, except using a catalyst from Comparative example 6 and eliminating the use of 1-hexene. The polymerization conditions and results were shown in Table 1.

### Comparative Example 23

Polymerization was carried out under the same conditions as in Comparative example 22, except using 20 mL of 1-hexene. The polymerization conditions and results were shown in Table 1.

TABLE 1

| | | 1- | activity | Ml | |
|---|---|---|---|---|---|
| | | hexene | (g polymer/g | (2.16 Kg, | density |
| No. | catalyst | (mL) | catalyst/hr) | g/10 min.) | (g/mL) |
| Example 5 | Example 1 | 60 | 9000 | 1.2 | 0.914 |
| Example 6 | Example 1 | 50 | 8300 | 1.1 | 0.916 |
| Example 7 | Example 1 | 40 | 5900 | 0.87 | 0.919 |
| Example 8 | Example 1 | 30 | 5200 | 0.47 | 0.920 |
| Comparative | Comparative | 60 | 6000 | 12.1 | 0.917 |
| example 7 | example 1 | | | | |
| Comparative | Comparative | 50 | 5600 | 4.6 | 0.919 |
| example 8 | example 1 | | | | |
| Comparative | Comparative | 40 | 5200 | 2.2 | 0.920 |
| example 9 | example 1 | | | | |
| Comparative | Comparative | 30 | 4900 | 1.2 | 0.922 |
| example 10 | example 1 | | | | |
| Example 9 | Example 2 | 80 | 2800 | 0.11 | 0.914 |
| Example 10 | Example 2 | 60 | 2600 | 0.12 | 0.916 |
| Example 11 | Example 2 | 50 | 2600 | 0.13 | 0.917 |
| Example 12 | Example 2 | 40 | 2400 | 0.12 | 0.919 |
| Comparative | Comparative | 80 | 2500 | 0.30 | 0.917 |
| example 11 | example 2 | | | | |
| Comparative | Comparative | 60 | 2200 | 0.40 | 0.920 |
| example 12 | example 2 | | | | |
| Comparative | Comparative | 50 | 2100 | 0.51 | 0.921 |
| example 13 | example 2 | | | | |
| Comparative | Comparative | 40 | 2200 | 0.53 | 0.924 |
| example 14 | example 2 | | | | |
| Example 13 | Example 3 | 70 | 4700 | 0.03 | 0.911 |
| Example 14 | Example 3 | 50 | 3600 | 0.02 | 0.914 |
| Example 15 | Example 3 | 40 | 3200 | 0.01 | 0.916 |
| Comparative | Comparative | 70 | 3000 | 0.76 | 0.913 |
| example 15 | example 3 | | | | |
| Comparative | Comparative | 50 | 2700 | 0.64 | 0.919 |
| example 16 | example 3 | | | | |
| Comparative | Comparative | 40 | 2400 | 0.76 | 0.921 |
| example 17 | example 3 | | | | |
| Example 16 | Example 4 | 70 | 1500 | T.L. | — |
| Example 17 | Example 4 | 40 | 1200 | T.L. | — |
| Comparative | Comparative | 70 | 1200 | 0.17 | 0.913 |
| example 18 | example 4 | | | | |
| Comparative | Comparative | 40 | 900 | 0.11 | 0.920 |
| example 19 | example 4 | | | | |
| Comparative | Comparative | 70 | N.A. | — | — |
| example 20 | example 5 | | | | |
| Comparative | Comparative | 20 | N.A. | — | — |
| example 21 | example 5 | | | | |
| Comparative | Comparative | 0 | N.A | — | — |
| example 22 | example 5 | | | | |
| Comparative | Comparative | 40 | N.A. | — | — |
| example 23 | example 6 | | | | |

* T.L. = too Low to be determined; N.A. = No Activity

The following Examples 18-24 and Comparative examples 24-32 illustrate polymerization reactions using hydrogen as a molecular weight modifier.

### Example 18

Polymerization was carried out by using the above prepared supported metallocene catalyst under the conditions shown in the following Table 2, according to the following method.

A pressure vessel was installed to the front end of 2 L stainless steel polymerization reactor and charged with the amount of hydrogen indicated in the following Table 2, and for the rest pressure, ethylene was added and mixed thereto so as to prepare a mixed gas of which total pressure was maintained at 330 psig. To this reactor, 1000 ml of purified hexane and 1-hexene of which amount was specified in Table 2 were introduced. Next, 1.0 cc of triisobutylaluminum (TiBA) diluted in 1M hexane as a catalytic poison remover was introduced into the reactor, stirred with temperature elevation and stopped stirring when reached to 65° C. As a main catalyst, 15-25 mg of the supported metallocene catalyst prepared in the forgoing step was weighed in a glove box and transferred to 5 ml syringe, and 1.0 cc triisobutylaluminum (TiBA) diluted in 1M hexane was added as an activator. The activated catalyst slurry was transferred and injected into a reactor at 65° C. Next, the reactor temperature was raised to 80° C. A hydrogen/ethylene mixed gas was fed so that the total pressure in the reactor reached to 200 psig, and the reaction was started by stirring at 1000 rpm. During the reaction, hydrogen/ethylene mixed gas was fed in a sufficient amount enough to consistently maintain the total pressure of the reactor at 200 psig, and the polymerization reaction was conducted for 20 minutes. After the polymerization reaction for 20 minutes, the ethylene/hydrogen mixed gas feed was stopped to terminate the reaction, thereby obtaining the polymer in result. The resulted polymer was separated through a filter, sufficiently dried to obtain the desired polymer. The polymerization results were shown in Table 2.

### Example 19

Polymerization was carried out under the same conditions as in Example 18, except adjusting the amount of hydrogen from 30 mL to 50 mL. The polymerization conditions and results were shown in Table 2.

### Example 20

Polymerization was carried out under the same conditions as in Example 18, except adjusting the amount of hydrogen to 30 mL and the amount of 1-hexene from 60 mL to 50 mL. The polymerization conditions and results were shown in Table 2.

### Example 21

Polymerization was carried out under the same conditions as in Example 18, except adjusting the amount of hydrogen to 30 mL and the amount of 1-hexene from 60 mL to 40 mL. The polymerization conditions and results were shown in Table 2.

### Comparative Example 24

Polymerization was carried out under the same conditions as in Example 18, except using a catalyst from Comparative example 1 and adjusting the amount of hydrogen from 30 mL to 50 mL. The polymerization conditions and results were shown in Table 2.

### Comparative Example 25

Polymerization was carried out under the same conditions as in Comparative example 24, except adjusting the amount of hydrogen to 30 mL. The polymerization conditions and results were shown in Table 2.

### Comparative Example 26

Polymerization was carried out under the same conditions as in Comparative example 24, except adjusting the amount of hydrogen to 30 mL and the amount of 1-hexene from 60 mL to 50 mL. The polymerization conditions and results were shown in Table 2.

### Comparative Example 27

Polymerization was carried out under the same conditions as in Comparative example 24, except adjusting the amount of hydrogen to 30 mL and the amount of 1-hexene from 60 mL to 40 mL. The polymerization conditions and results were shown in Table 2.

### Example 22

Polymerization was carried out under the same conditions as in Example 18, except using a catalyst from Example 2 and adjusting the amount of hydrogen to 50 mL and the amount of 1-hexene to 70 mL. The polymerization conditions and results were shown in Table 2.

### Example 23

Polymerization was carried out under the same conditions as in Example 18, except using a catalyst from Example 2 and adjusting the amount of hydrogen to 70 mL and the amount of 1-hexene to 70 mL. The polymerization conditions and results were shown in Table 2.

### Example 24

Polymerization was carried out under the same conditions as in Example 18, except using a catalyst from Example 2 and adjusting the amount of hydrogen to 100 mL and the amount of 1-hexene to 70 mL. The polymerization conditions and results were shown in Table 2.

### Comparative Example 28

Polymerization was carried out under the same conditions as in Example 18, except using a catalyst from Comparative example 1 and adjusting the amount of hydrogen from 30 mL to 50 mL and the amount of 1-hexene to 70 mL. The polymerization conditions and results were shown in Table 2.

### Comparative Example 29

Polymerization was carried out under the same conditions as in Comparative example 28, except adjusting the amount of hydrogen to 70 mL. The polymerization conditions and results were shown in Table 2.

### Comparative Example 30

Polymerization was carried out under the same conditions as in Comparative example 28, except adjusting the amount of hydrogen to 100 mL. The polymerization conditions and results were shown in Table 2.

### Comparative Example 31

Polymerization was carried out under the same conditions as in Example 18, except using a catalyst from Comparative example 5 and adjusting the amount of hydrogen to 30 mL and the amount of 1-hexene to 70 mL. The polymerization conditions and results were shown in Table 2.

### Comparative Example 32

Polymerization was carried out under the same conditions as in Comparative example 31, except adjusting the amount of 1-hexene to 20 mL. The polymerization conditions and results were shown in Table 2.

TABLE 2

| | | | hydrogen | | MI | |
|---|---|---|---|---|---|---|
| | | 1-hexene | amount | activity (g polymer/g | (2.16 Kg, | density |
| No. | catalyst | (mL) | (mL) | catalyst/hr) | g/10 min.) | (g/mL) |
| Example 18 | Example 1 | 60 | 30 | 8700 | 2.7 | 0.912 |
| Example 19 | Example 1 | 60 | 50 | 6800 | 4.4 | 0.913 |
| Example 20 | Example 1 | 50 | 30 | 7400 | 1.5 | 0.917 |
| Example 21 | Example 1 | 40 | 30 | 5300 | 0.74 | 0.919 |
| Comparative | Comparative | 60 | 30 | 5400 | 47 | 0.915 |
| example 24 | example 1 | | | | | |
| Comparative | Comparative | 60 | 50 | 4900 | 89 | 0.917 |
| example 25 | example 1 | | | | | |
| Comparative | Comparative | 50 | 30 | 5600 | 8.6 | 0.919 |
| example 26 | example 1 | | | | | |
| Comparative | Comparative | 40 | 30 | 3800 | 4.9 | 0.921 |
| example 27 | example 1 | | | | | |
| Example 22 | Example 2 | 70 | 50 | 3800 | 0.14 | 0.916 |
| Example 23 | Example 2 | 70 | 70 | 4900 | 0.41 | 0.919 |
| Example 24 | Example 2 | 70 | 100 | 4300 | 0.52 | 0.920 |
| Comparative | Comparative | 70 | 50 | 3200 | 0.72 | 0.918 |
| example 28 | example 2 | | | | | |
| Comparative | Comparative | 70 | 70 | 4100 | 1.44 | 0.921 |
| example 29 | example 2 | | | | | |
| Comparative | Comparative | 70 | 100 | 3600 | 2.31 | 0.922 |
| example 30 | example 2 | | | | | |
| Comparative | Comparative | 70 | 30 | N.A. | — | — |
| example 31 | example 5 | | | | | |
| Comparative | Comparative | 20 | 30 | N.A. | — | — |
| example 32 | example 5 | | | | | |

*) N.A. = No Activity

In the above Table 1, provided are the polymerization results from copolymerization of ethylene and 1-hexene, without using a hydrogen, i.e. a molecular weight modifier, by using the supported catalysts from Examples 1-4 of which metallocene catalyst component are different, the catalysts from Comparative examples 1-4 which did not use another characteristic component of the present invention, i.e., a titanocene compound, or the catalysts from Comparative examples 5-6 prepared by only using a titanocene compound. As seen from Table 1, firstly, the catalysts from Comparative examples 5-6 prepared by only using a titanocene compound did not show catalyst activity at all. It can be found out that the supported catalysts from Examples 1-4 according to the present invention have superior catalyst activity to the catalysts from Comparative example 1-4, and regarding the melt index of the polymer that is a molecular weight index, provide low melt index (MI) indicating that the molecular weight of the polymer has been adjusted relatively largely. It is further found out that regarding density of the polymer, the supported catalysts from Examples 1-4 are lower than those of Comparative examples 1-4. This indicates the supported catalysts from Examples 1-4 are superior to those from Comparative examples in terms of copolymerization reactivity. Such result has a significant meaning that it is closed to a commercial production conditions as particularly, it was resulted in a relatively low density range.

In the above Table 2, provided are the polymerization results from copolymerizing ethylene and 1-hexene in the presence of a hydrogen, i.e., a molecular weight modifier, by using the supported catalysts from Examples 1-2, the catalysts from Comparative examples 1-2 prepared without the use of a titanocene compound that is another component of the present invention, or the catalysts from Comparative example 5 prepared by only using a titanocene compound. From the results, it is found out that the catalysts of the present invention, even in the presence of hydrogen, has excellent catalyst activity; and provides a low melt index (MI) of the polymer, that is a molecular weight index and a lower density of the polymer compared to catalysts from Comparative examples.

1. A catalyst for olefin (co)polymerization prepared by the method comprising:
(1) supporting aluminoxane, a metallocene compound and a titanocene compound or half-titanocene compound onto a support, wherein the molar ratio of the titanocene compound or half-titanocene compound to the metallocene compound is 0.03:1-10:1, wherein the metallocene compound is selected from the compounds having the chemical formulas (1) to (3), and wherein the titanocene compound or half-titanocene compound is selected from the compounds having the chemical formula (4):
(CpRₙ)(CpR′ₘ)ML_{q} (1)
wherein Cp is a cyclopentadienyl, indenyl or fluorenyl;
each of R and R′ independently is hydrogen, alkyl, alkylether, allylether, phosphine or amine;
L is an alkyl, allyl, arylalkyl, amide, alkoxy or halogen;
M is a transition metal of Group 4 or 5 in the periodic table; and
each of n, m and q is an integer within the following range: 0≦n<5, 0≦m<5, and 1≦q≦4;
Q(CPRₙ)(CpR′ₘ)ML_{q} (2)
wherein, each of Cp, R, R′, M and L has the same meaning as defined in the chemical formula (1);
Q is a crosslinkage between the carbon rings, which is selected from dialkyl, alkylaryl, diaryl silicon or C1-C20 hydrocarbon group; and
each of n, m and q is an integer within the following range: 0≦n<4, 0≦m<4, and 1≦q≦4; 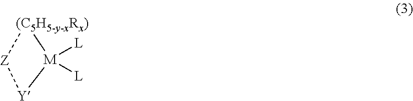
wherein, x is 0, 1, 2, 3 or 4; y is 0 or 1;
R is hydrogen, or a substituent having 1-20 non-hydrogen atom(s) selected from the group consisting of C1-C20 hydrocarbon group, silyl, germyl, cyano, halogen and a combination thereof;
Y′ is —O—, —S—, —NR*—, or —PR*—, wherein R* is hydrogen, C1-C12 hydrocarbon group, C1-C8 hydrocarbyloxy, silyl, C1-C8 halogenated alkyl, C6-C20 halogenated aryl or a combination thereof;
Z is SiR*₂, CR*₂, SiR*₂SiR*₂, CR*₂CR*₂, CR*═CR*, CR*₂SiR*₂ or GeR*₂, wherein R* is as previously defined;
each L independently is a substituent having 1-20 non-hydrogen atom(s) selected from the group consisting of halide, C1-C20 hydrocarbon group, C1-C18 hydrocarbyloxy, C1-C19 hydrocarbylamino, C1-C18 hydrocarbylamide, C1-C18 hydrocarbylphosphide, C1-C18 hydrocarbylsulfide and a combination thereof, or two Ls together represent C1-C30 neutral conjugated dien or divalent group; and
M is a transition metal of Group 4 or 5 of the periodic table;
(CpRₙ)(CpR′ₘ)TiL_{q} (4)
wherein, Cp is cyclopentadienyl, indenyl, tetrahydroindenyl or fluorenyl;
each of R and R′ independently is hydrogen, C1-C20 hydrocarbon group, alkylether, alkylsilyl, allylether, alkoxyalkyl, phosphine or amine;
L is alkyl, allyl, arylalkyl, amide, alkoxy or halogen; and
each of n, m and q is an integer within the following range: 0≦n<5, 0≦m<5 and 1≦q≦4;
(2) washing the supported catalyst obtained from the above step (1) with an organic solvent; and
(3) drying the catalyst washed from the above step (2) and thus collecting the catalyst in the form of powder.

2. The catalyst according to claim 1, wherein the supporting of the step (1) is conducted by adding a solution obtained by dissolving the metallocene compound together with the titanocene compound or half-titanocene compound in aluminoxane solution to a support slurry, and stirring the mixture.

3. The catalyst according to claim 1, wherein the supporting of the step (1) is conducted by adding aluminoxane to a support slurry and stirring the mixture so as to obtain an aluminoxane supported support slurry, and adding thereto the metallocene compound and the titanocene compound or half-titanocene compound and stirring the mixture.

4. The catalyst according to claim 1, wherein the support is silica having the average particle size of 10-250 μm; micropores of which average diameter is 50-500 Å and volume is 0.1-10 ml/g; and the surface area of 5-1000 m²/g.

5. The catalyst according to claim 1, wherein the aluminoxane is selected from linear aluminoxane oligomers and cyclic aluminoxane oligomers.

6. A method for polymerizing olefins or copolymerizing olefin with comonomer(s) by using a catalyst according to claim 1.

7. A method for polymerizing olefins or copolymerizing olefin with comonomer(s) by using a catalyst according to claim 2.

8. A method for polymerizing olefins or copolymerizing olefin with comonomer(s) by using a catalyst according to claim 3.

9. A method for polymerizing olefins or copolymerizing olefin with comonomer(s) by using a catalyst according to claim 4.

10. A method for polymerizing olefins or copolymerizing olefin with comonomer(s) by using a catalyst according to claim 5.
